(19) United States
(12) Patent Application Publication
(10) Pub. No.: US 2003/0164995 A1
(43) Pub. Date: Sep. 4, 2003

(54) Optical device and method for scanner

(76) Inventors: Chuan-Yu Hsu, Hsinchu (TW); Ji-Mei Tsuei, Hsinchu (TW); Po-Hua Fang, Hsinchu (TW)

Correspondence Address: Raymond Sun, 12420 Woodhall Way, Tustin, CA, 92782, US

(21) Appl. No.: 10/174,888

(22) Filed: Jun. 19, 2002

(30) Foreign Application Priority Data
Sep. 4, 2001 (TW) 90121808

(51) Int. Cl. H04N 1/46

(52) U.S. Cl. 358/509

(57) ABSTRACT

A optical device and method for scanner that includes at least a concave mirror, a image device, a stop and a image adjusting module. The concave mirror is with a reflecting surface to focus light and reflect said light to a pre-determined route. The image device can receive the light reflected from at least a concave mirror and convert the light into digital signal. Said stop is on the light traveling route between the image device and at least a concave mirror to reject the extra light. The said image adjusting module is used to adjust the image formed by at least one of the said concave mirrors. The method of adjusting the scanned image will multiply the scanned image by a 2-dimensional enlarging value, said method also cover adjusting the MTF value of the image that near the two ends of the object being scanned.

### BACKGROUND OF THE INVENTION

(a). Field of the Invention

The present invention relates to an optical device and method for scanner. Especially, the present invention relates to an optical device which has a concave mirror, a stop to reject extra light and a method of adjusting the resulting image scanned by the optical device of the present invention.

(b). Description of the Prior Arts

Please refer to FIG. 1, the embodiment is showing a traditional flat bed optical scanner. There is a document window glass 12 on the case 11 of the scanner 1 which holding a original document that waiting to be scanned by a optical chassis 14 which is, in the hollow case 11, driven by a driving device 13 along with the guiding bar 15.

FIG. 2 is showing the A-A profile of the optical chassis 14 of a traditional flat bed optical scanner 1 in FIG. 1. The optical chassis 14 comprises a hollow case 141, a light source 142 on a proper position of one side of said hollow case 141, a light guiding device consisted of multiple reflecting mirrors 143, a lens set 144 and a charge couple device (CCD) 145. The said light source 142 will shoot a light to the original document on the document window glass 12. The light reflects into the case body 141 of the said optical chassis 14, and the said multiple reflecting mirrors 143 reflect the light a few times to make the optical length longer and to be a proper one, and the said lens set 144 will focus the light and form the image on the said charge couple device (CCD) 145, then, the data of the image will be converted into digital signals. The total track of the light traveling in the said above process is equal to the value of Y1+Y2+ . . . +Y5 in FIG. 2.

FIG. 1. and FIG. 2. are showing a traditional optical chassis 14, of which lens set 144 is consisted of many components, such as concave mirrors. And because the structure of said lens set 144 is complex and is difficult to assemble, the production cost is high. More, the said lens set 144 create chromatic dispersion effect, which damages the quality of the scanning. More over, a said reflecting mirror 143 is made of a thin glass coated by silver, it need many such kind of glasses to reflect the light when scanning, and which even worsen the effect of chromatic dispersion. Additionally, the said multiple reflecting mirrors 143 need extra springs, fixers and special matching screws to fix on the pre-determined position in the inner side of the case body 141. It is pretty difficult to assemble and the cost is therefore high.

### SUMMARY OF THE INVENTION

The present invention relates to an optical device and method for scanner. Especially, the present invention relates to an optical device which has a concave mirror, a stop to reject extra light and a method of adjusting the resulting image scanned by the optical device of the present invention.

In one aspect of the present invention is that the said invention provides an optical device and method for scanner which does not use the traditional lens set but adopts a concave mirror and a stop to focus the light and form the image, which reduce the manufacturing cost and the effect of chromatic dispersion.

In another aspect of the present invention is that the said invention provides an optical device and method for scanner that adopt concave mirror to focus light and to form image, as well as a image adjusting method to adjust the enlarging ratio of image and the value of MTF.

The third aspect of the present invention is that the said invention provides an optical device and method for scanner that its concave mirror is made by bendable thin plated panel facing the coming light, which avoid the problem of chromatic dispersion, most of time, that caused by reflecting glass in prior art.

The forth aspect of the present invention is that the said invention provides an optical device and method for scanner, and there are several pre-determined curve-shaped surface in the inner side of the scanner. And integrating the bendable thin plated concave mirror mentioned above with the curve-shaped surface will form the pre-determined curve-shaped concave mirror and complete the work of positioning easily. This also simplify the process of assembling and reduce the manufacturing cost substantially.

The appended drawings will provide further illustration of the present invention, together with the description, serve to explain the principles of the invention.

### BRIEF DESCRIPTION OF THE DRAWINGS

FIG. 1 shows a traditional optical scanner in prior art.

FIG. 2 shows the optical chassis of a traditional optical scanner and a light guiding device thereof.

FIG. 3A shows the top view, front view and side view of the No. 1 concave mirror of the embodiment of the present invention.

FIG. 3B shows the top view, front view and side view of the No. 2 concave mirror of the embodiment of the present invention.

FIG. 3C shows the top view, front view and side view of the No. 3 concave mirror of the embodiment of the present invention.

FIG. 4A shows the first embodiment of the stop of the present invention.

FIG. 4B shows the second embodiment of the stop of the present invention.

FIG. 4C shows the third embodiment of the stop of the present invention.

FIG. 5A shows the first application embodiment of the optical device of the present invention.

FIG. 5B shows the second application embodiment of the optical device of the present invention.

FIG. 6A shows a preferred embodiment of an adjusted diagram of the present invention.

FIG. 6B shows an embodiment of scanned image of said adjusted diagram in FIG. 6A.

FIG. 7 shows a preferred embodiment of the method of adjusting image of the optical device of the present invention.

FIG. 8 shows a preferred embodiment of the integration of the case and the concave of the optical device of the present invention.

FIG. 9 shows a partial enlarged 3D diagram of the B area of FIG. 8.

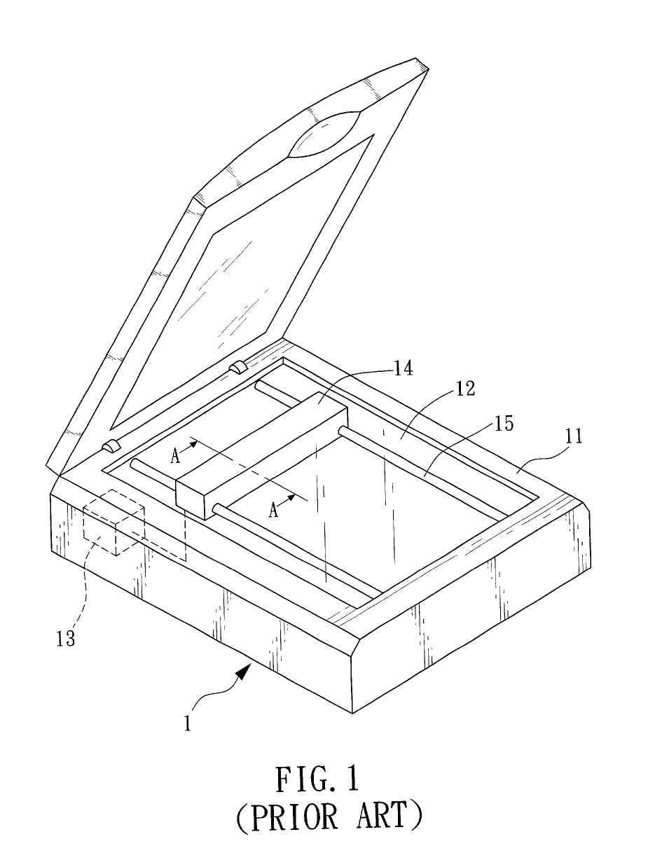

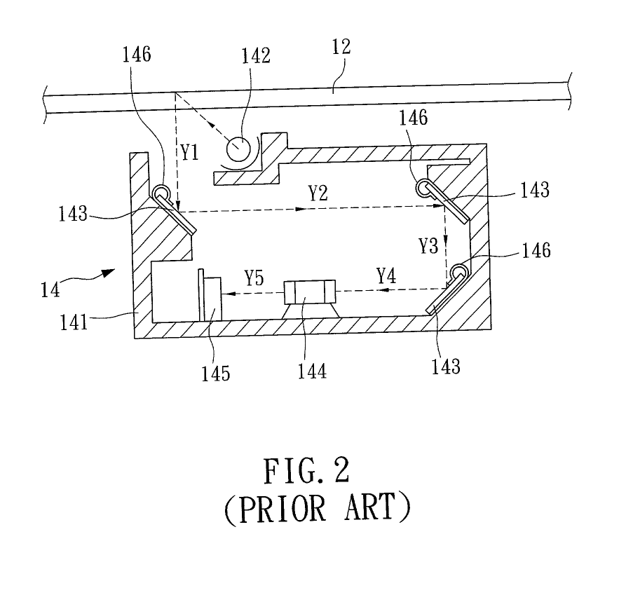

### DETAILED DESCRIPTION OF THE PRESENT INVENTION

The present invention relates to an optical device and method for scanner. Especially, the present invention relates to an optical device which is using a concave mirror instead of the traditional lens set in prior art, and a stop to reject extra light to obtain better image quality. In order to avoid the problem of image distortion caused by the concave mirror, the present invention also provide a method to adjust the resulting image scanned by the optical device of the present invention.

The following embodiments will illustrate detail information of the operation, the method, the effect of the optical device of the present invention.

In order to explain more detail about the features and the embodiment of the present invention, the follows will introduce a couple of embodiments of concave mirror and stop of the optical device of the present invention.

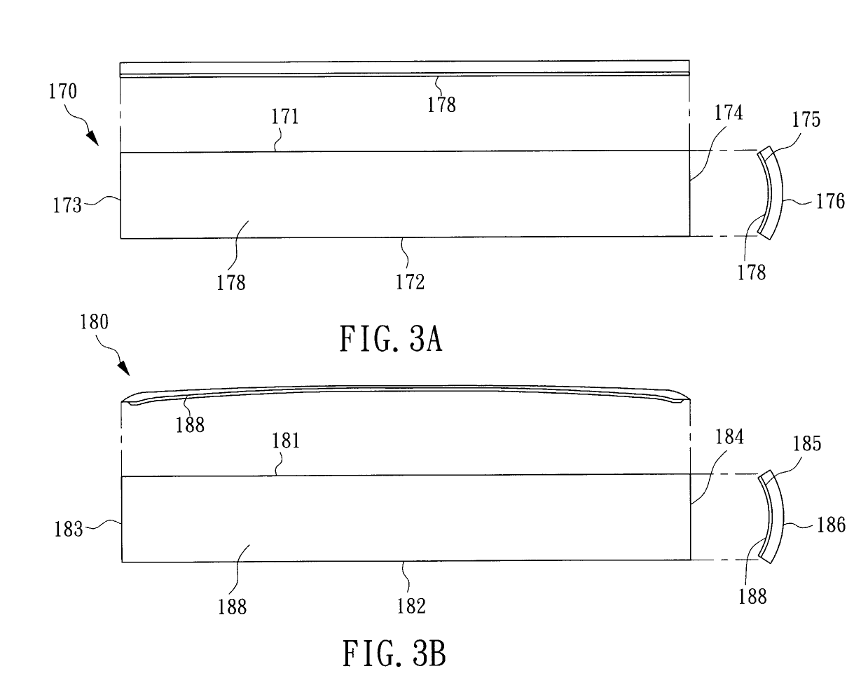

As shown in FIG. 3A, FIG. 3B, and FIG. 3C, there are three different types of embodiments of the concave mirror of the present invention, they respectively has different type of No. 1 concave mirror 170, No. 2 concave mirror 180 and No. 3 concave mirror 190.

As shown in FIG. 3A, the No. 1 concave mirror 170 is with cylinder-shaped (or tub-shaped) surface. The No. 1 concave mirror 170 has two parallel long sides (the first long side 171 and the second long side 172), two short sides (the first short side 173 and the second short side 174) intersecting the said two long sides and the area (the first plane surface 175 and the second plane surface 176) determined by the long sides and the sort sides. Bending the two short sides 173 and 174 toward the same direction but keeping the long sides 171 and 172 steel, on the No. 1 concave mirror 170, will make the first plane surface 175 concave and the second plane surface 176 convex and form the No. 1 concave mirror 170.

As shown in FIG. 3B, the No. 2 concave mirror 180 is with round-shaped (or oval-shaped) surface. The No. 2 concave mirror 180 has two parallel long sides (the first long side 181 and the second long side 182), two short sides (the first short side 183 and the second short side 184) intersecting the said two long sides and the area (the first plane surface 185 and the second plane surface 186) determined by the long sides and the sort sides. Bending the two short sides 183 and 184 and the long sides 181 and 182 toward the same direction, on the No. 1 concave mirror 170, will make the first plane surface 185 concave and the second plane surface 186 convex and form the No. 2 concave mirror 180.

As shown in FIG. 3C, the No. 3 concave mirror 190 is with cylinder-shaped (or tub-shaped) surface. The No. 3 concave mirror 190 has two parallel long sides (the first long side 191 and the second long side 192), two short sides (the first short side 193 and the second short side 194) intersecting the said two long sides and the areas (the first plane surface 195 and the second plane surface 196) determined by the long sides and the sort sides. Bending the two long sides 191 and 192 toward the same direction but keeping the short sides 193 and 194 steel, on the No. 3 concave mirror 190, will make the first plane surface 195 concave and the second plane surface 196 convex and form the No. 3 concave mirror 190.

In a preferred embodiment, each concave mirror 170, 180, 190 can be made of non-glass bendable thin board material, and there is a plated reflecting layer 178, 188, 198 in the concave side of the board (the first plane surface 175, 185, 195) to provide function of reflecting light. Wherein, the material plated on the said plated reflecting layer 178, 188, 198 can be silver, chromium, aluminum, platinum or other material with excellent reflecting feature. The method to make the said plated reflecting layer can be evaporating sputtering, sputtering, chemical deposition or others. The said plated reflecting layer 178, 188, 198 can be single layer or multiple layers and the material of the thin board can be paper, plastic, gum, high-polymer, fiber glass, rubber, thin metal slice and other non-glass but bendable material. The bendable material that we mentioned here is referred to a material with proper hardness to keep itself in flat shape and in good condition to reflect light. When external force applying, the material can bear the force and bend properly to form a concave mirror like 170, 180, 190 but not to break. Another advantage is that the bendable material is easy to be manufactured in different shape and can be used in different fields. On the contrary, the reflecting lens that made of glass material in prior art is easy to break and is hard to bend in the production process, so, the usage is limited.

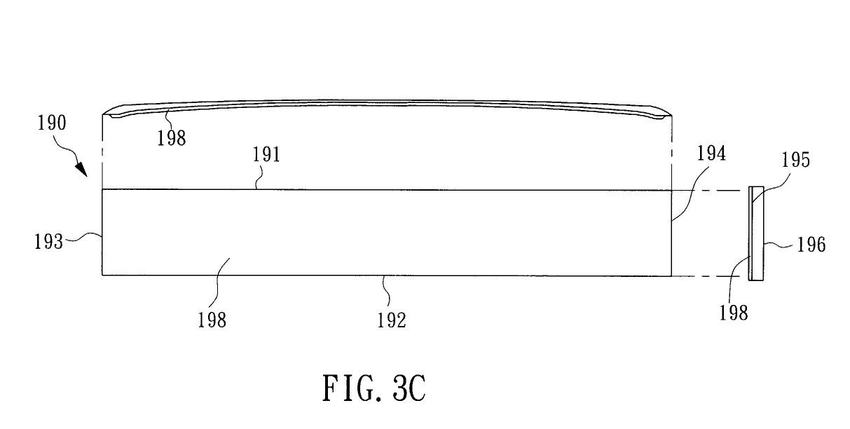

FIG. 4A, FIG. 4B and FIG. 4C show three preferred embodiments of the stop of the present invention. In FIG. 4A, the stop has a round light pass-through hole 81, the diameter of the said round light pass-through hole 81 is better between 2 mm to 6 mm, and the rest area of the stop should be non-transparent. The reason that the diameter of the said round light pass-through hole 81 limited between 2 mm to 6 mm is because, the hole will not reject the extra light if the diameter is too big, and the light will detour if the diameter is too small, either of which will cause bad quality of image being scanned. In the FIG. 4B, the hole of the stop 80a that let the light pass through is a horizontally extended strap-shaped hole 81a, the width of the narrow side of the said hole 81a is better between 2 mm to 6 mm. In FIG. 4C, the number of the light pass-through hole 81b of the stop 80b is multiple and the said holes are arranged horizontally in strap shape, the width (or diameter) of each said holes 81b is better limited between 2 mm to 6 mm.

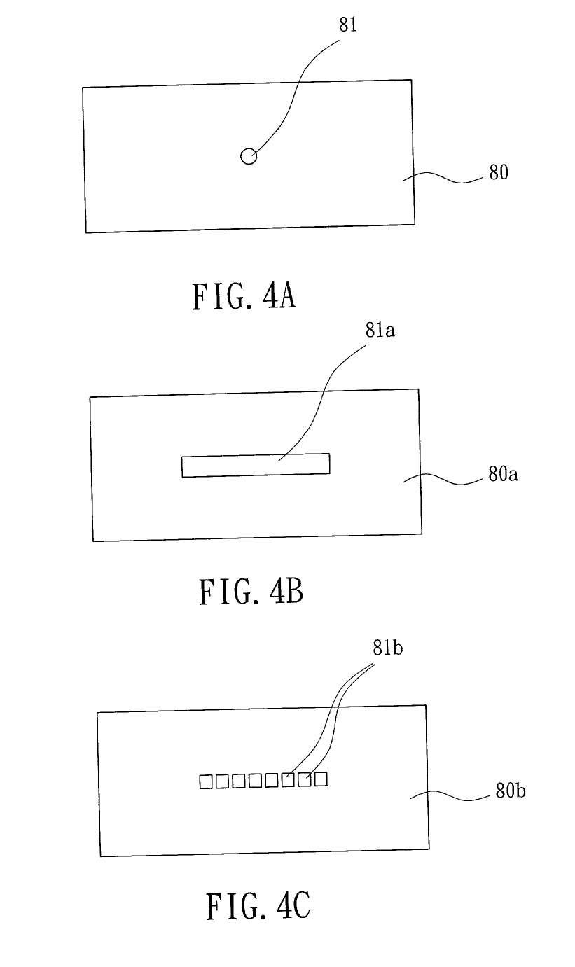

FIG. 5A and FIG. 5B show two different embodiments of the present invention.

As shown in FIG. 5A, the preferred embodiment of the optical device 8 of the present invention comprises a concave mirror 190, two flat mirrors 831 and 832, a stop 80 and an image device 86. When reflecting scan model has been used to scan the object 84, the first light source 851 shot light to the object 84, the object 84 will reflect the light and the reflected light will enter into the optical device 8. After the light being reflected a few times by the concave mirror 190 and the flat mirror 831 and 832, the stop 80 will reject the extra light and the image of the object 84 will show on the image device 86. When penetrating scan model has been used to scan the object 84, the second light source 852 shot light to the object 84, and the light will penetrate the object 84 and enter into the optical device 8. In this preferred embodiment, the image device 86 accepts the light reflected from the concave mirror 190, the flat mirror 831 and 832 and converted the reflected light into digital signal. The image device 86 can be a CCD, a CMOS image capture device or any other device that can convert the light into digital signal.

FIG. 5A shows one embodiment, wherein the effect will be better if the concave 190 mirror can be the concave mirror 180 (mirror No. 2) shown in FIG. 3B or the concave mirror 190 (mirror No. 3) shown in FIG. 3C, because the longer side of both concave mirrors are curve-shaped and the concave reflecting sides (the first surface 185, 195) of both concave mirrors focus the image scanned and reflect light along a predetermined route. The flat mirror 831, 832 are used to reflect light along a predetermined route and therefore make the traveling length of light longer, but what happened is a flat mirror could not focus and reflect light. The stop 80 is on the light traveling route between the image device 86 and a concave mirror (or a flat mirror). In a preferred embodiment, the round light pass-through hole 81 of the stop 80 is near the spot of the light focused and that will provide better light filtering effect. To have better effect, the image device 8 can be put on an additional image adjusting module 87 to adjust the image that focused by the concave mirror 190. The detailed information of the image adjusting module 87 will be described later.

FIG. 5B shows the second preferred embodiment of the optical device 8a of the present invention, wherein the optical device 8a comprises three flat mirrors 833, 834, 835, a No. 1 concave mirror 170, a No. 3 concave mirror 190, a stop 80 and a image device 86. The difference between this embodiment and the embodiment shown in the FIG. 5A is, in this embodiment, with more reflecting mirrors and a proper light track design, the size of the optical device 8a is smaller but the total track of light traveling is the same. More over, with the focus function of the concave mirror 170, the brightness of the image scanned can be increased; the distortion of image caused by the No. 3 concave mirror 190 will be reduced. FIG. 5B shows an additional image adjusting module 87 on the optical device 8a that can be used to adjust the image focused by the No. 3 concave mirror 190.

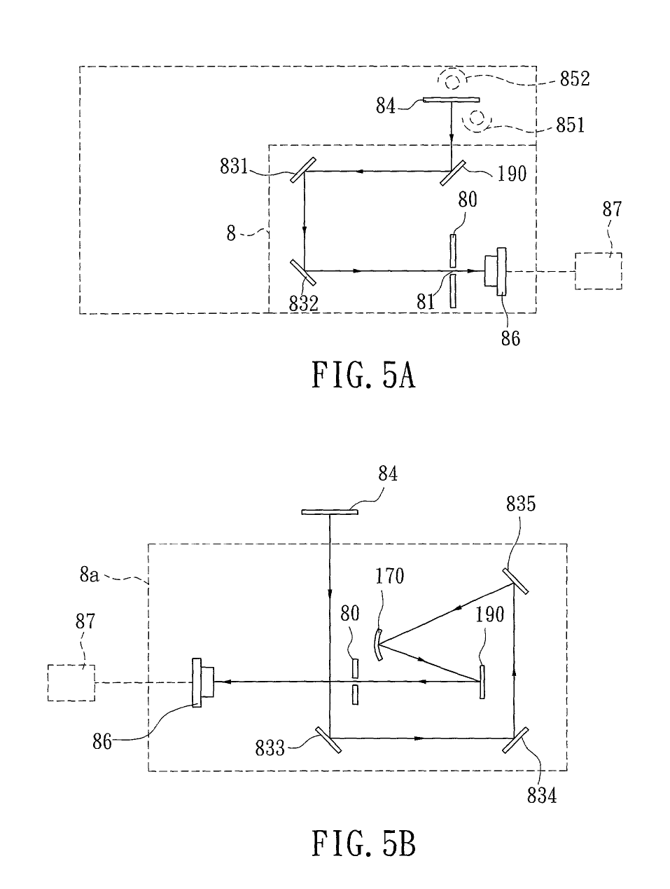

In prior art, an optical device conventionally uses linear CCD to capture image, such a structure as the No. 3 concave mirror will cause the scanned image a 2-dimensional unbalanced enlargement. For example, if a diagram 88 shown in the FIG. 6A scanned by the optical device 8 with the No. 3 concave mirror shown in the FIG. 5A, due to the enlarging ratios of the x axle and y axle of the No. 3 concave mirror are different, the scan result will be like as the image 89 shown in the FIG. 6B. By calculating the number of the image pixels in the image 89 and to compare the 2-dimensional distance between the pixels in the image of the diagram 88, we can get a 2-dimensional enlarging ratio and store it in a memory module. So, later on, when user using the optical device 8 to scan a object, he can just multiple the scanned image by the value (in 2 dimensions) of the ratio stored previously in the memory module to get the original and correct image.

The problem that the No. 2 concave mirror and the No. 3 concave mirror causing, when scanning a object, the value of MTF reduced on both two ends of the object scanned will be corrected by the technology of adjusting the value of MTF. However, the disclosure of the technology of adjusting MTF value is not covered in this specification, to who it may concern, the Taiwan patent No. 338216 could be a reference.

The image adjusting module 87 is designed to adjust the enlarging ratio and the value of the MTF.

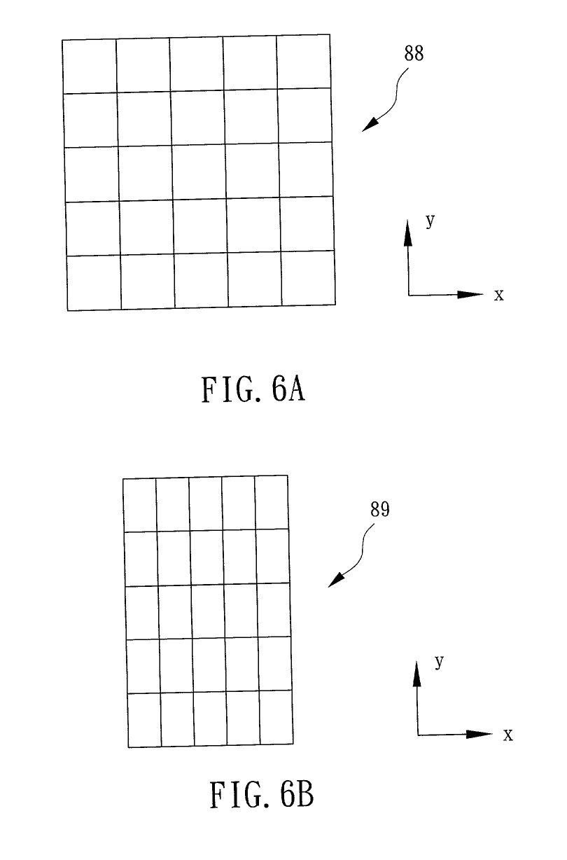

As shown in FIG. 7, the image adjusting method of the optical device of the present invention comprises the following steps,

step 91: to scan an object along with the scanning direction to obtain a scanned image,

step 92: to multiple the scanned image by the values (in 2 dimensions) of the ratio stored previously to get the original and correct image,

step 93: to adjust the value of MTF on both two ends of the object scanned,

step 94: to obtain a output image.

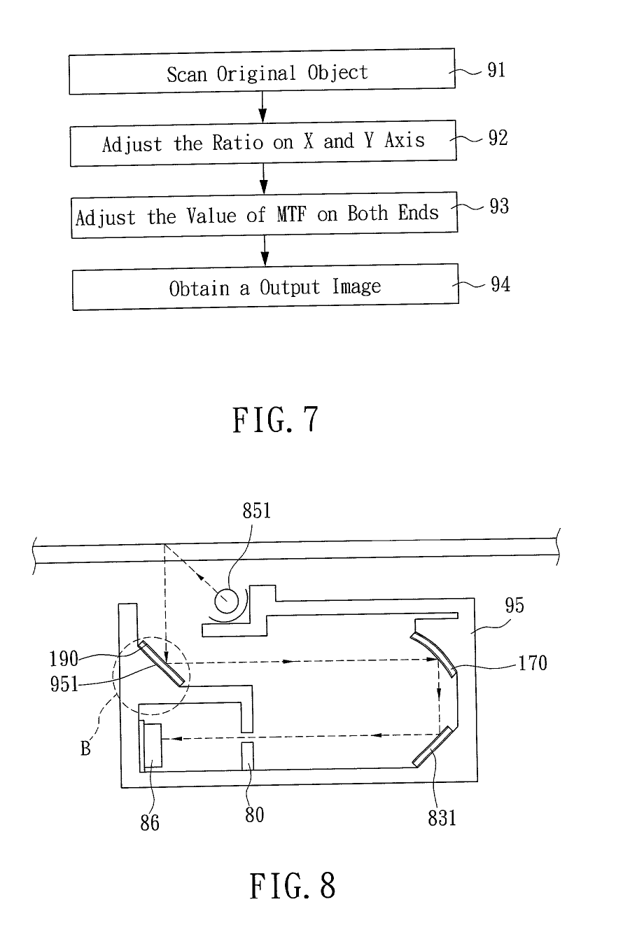

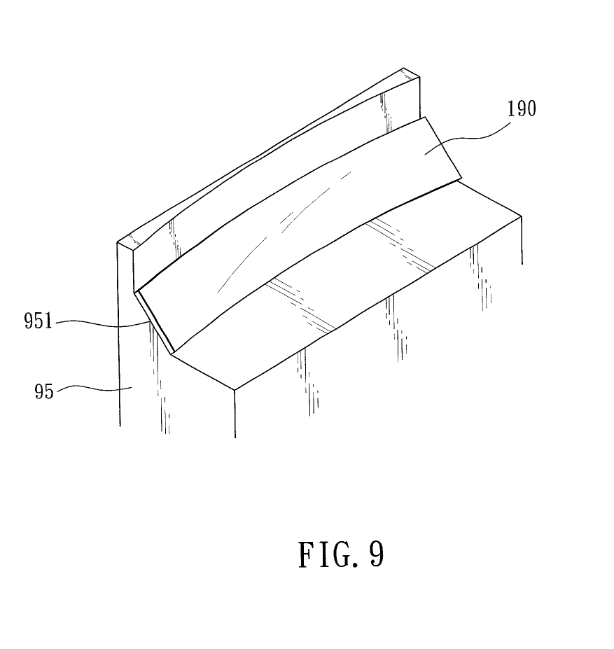

Please refer to FIG. 8 and FIG. 9, there is another embodiment of the present invention which comprises a case 95 containing concave mirrors 190, 170, a flat mirror 831, a light source 851, a image device 86 and a stop 80, more over, in the inner side of the case 95, there are a few pre-determined combining areas 951 with certain angle to position and hold the said concave mirror 170, 190 and the said flat mirror 831. The said pre-determined combining areas 951 is designed to match the curve-shaped of the said concave mirror 190, so, the said concave mirror 190 can be positioned and placed directly into the said pre-determined combining areas 951 easily. As described previously, the concave mirror is better made of bendable material and can be positioned and connected with the said combining areas 951 directly. So, when assembling the optical device 8, a thin flat bendable component with reflecting coated material can be positioned and placed on the said combining areas 951 of the case 95 to form the said concave mirror 190 directly. For the material is bendable and non-glass, it is easy to assemble in many ways and the manufacturing cost is low.

While the present invention has been shown and described with reference to a preferred embodiment thereof, and in terms of the illustrative drawings, it should be not considered as limited thereby. Various possible modification, omission, and alterations could be conceived of by one skilled in the art to the form and the content of any particular embodiment, without departing from the scope and the sprit of the present invention.

What is claimed is:

1. A optical device for scanner that can accept the light reflected from the object scanned, and said optical device comprises:
at least a concave mirror with a reflecting surface to focus light and reflect said light to a pre-determined route,
a image device that can accept the light reflected from a concave mirror and convert the light into digital signal,
a stop that is on the light traveling route between said image device and at least a concave mirror to reject the extra light,

2. The optical device for scanner of claim 1, wherein said stop has at least a light pass-through hole.

3. The optical device for scanner of claim 2, wherein said light pass-through hole is a horizontally extended strap-shaped light pass-through hole.

4. The optical device for scanner of claim 2, wherein the number of said light pass-through hole is multiple and said holes are arranged horizontally into a long strap format.

5. The optical device for scanner of claim 1, wherein said concave mirror is with two parallel long sides intersecting with two short sides, and said concave mirror is with the first plane surface and the second plane surface that defined by said long sides and said short sides.

6. The optical device for scanner of claim 5, wherein bending said two short sides will form a concave mirror that said first plane surface concave and said second plane surface convex.

7. The optical device for scanner of claim 5, wherein bending the said two long sides will form a concave mirror that said first plane surface concave and said second plane surface convex.

8. The optical device for scanner of claim 5, wherein bending said two long sides and said two short sides in the same time will form a concave mirror that said first plane surface concave and said second plane surface convex.

9. The optical device for scanner of claim 1, wherein said device has at least one flat mirror on the light traveling path to reflect light.

10. The optical device for scanner of claim 1, wherein said device has at least a image adjusting module to adjust the light image formed by at least one concave mirror.

11. The optical device for scanner of claim 1, wherein each concave mirror is made of thin board, and one side of each said board is coated with reflecting material.

12. The optical device for scanner of claim 11, wherein, said coated side is on the inner concave side of said concave mirror.

13. The optical device for scanner of claim 1, wherein said device comprises a case that is containing and holding concave mirrors, image devices and stops, and on some pre-determined positions of said case, certain angle and shape is made to hold at least a corresponding concave mirror.

14. The optical device for scanner of claim 13, wherein said pre-determined positions of said case is made in certain shape to match the curve-shaped concave mirror, so said concave mirror can be placed on said position directly without any modification.

15. The optical device for scanner of claim 14, wherein said concave mirror is made of bendable material and can be placed on said pre-determined position directly to form a concave mirror.

16. The optical device for scanner of claim 1, wherein the number of the concave mirror is multiple.

17. The optical device for scanner of claim 16, wherein the multiple concave mirrors are in the same curve shape.

18. The optical device for scanner of claim 16, wherein said multiple concave mirrors are in at least two different curve shape.

19. The optical device for scanner that will receive the light reflected from a object, wherein said device comprises at least one concave mirror with a reflecting side to focus and reflect light to a pre-determined direction; one image device to receive the light reflected from a concave mirror and convert said light into digital signal, more over, said device does not have lens set and convex mirror but has one stop with at least one light pass-through hole on the light traveling path to reject the extra light.

20. The optical device for scanner of claim 19, wherein said device comprises at least one flat mirror on the light traveling path to reflect light.

21. The optical device for scanner of claim 19, wherein said device has at least a image adjusting module to adjust the light image formed by at least one concave mirror.

22. The optical device for scanner of claim 19, wherein each said concave mirror is made of thin board, and one side of each said board is coated with reflecting material.

23. The optical device for scanner of claim 22, wherein said device comprises a case that is containing and holding concave mirrors, image devices and stops, and on some pre-determined positions of said case, certain angle and shape is made to hold at least a corresponding concave mirror, said pre-determined positions of said case is made in certain shape to match the curve-shaped concave mirror, so said concave mirror can be placed on the said position directly without any modification to form a concave mirror.

24. The image adjusting method of a optical device for scanner, wherein said image adjusting method comprises the following steps:
scanning a object along with a certain direction to obtain a scanned image,
multiplying the scanned image by the pre-determined 2-dimensional enlarging ratio,
adjusting the value of MTF that near the two ends of the scanned image,
obtaining a output image.

25. The image adjusting method of a optical device for scanner of claim 24, wherein the method of calculating the image enlarging ratio comprises the following steps:
providing a corrected diagram,
scanning the corrected diagram and obtaining the scanned image of the corrected diagram,
calculating the 2-dimensional distance difference between the pixels that on said scanned image of the corrected diagram and the scanned image of the scan object and convert the difference into enlarging ratio,
storing the enlarging ratio for image adjusting use.

26. The image adjusting method of a optical device for scanner of claim 24, wherein said method is to be used in said optical device in claim 1.
